(19) United States
(12) Patent Application Publication
(10) Pub. No.: US 2004/0047057 A1
(43) Pub. Date: Mar. 11, 2004

(54) Substrate for material to be exposed

(76) Inventors: Patrick Pouteau, Voreppe (FR); Patrick Chaton, Theys (FR); Francois Perraut, Saint Joseph De Riviere (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/450,386

(22) PCT Filed: Dec. 12, 2001
(86) PCT No.: PCT/FR01/03959

(30) Foreign Application Priority Data
Dec. 14, 2000 (FR) 00/16315

(51) Int. Cl. G02B 5/08; G02B 7/182

(52) U.S. Cl. 359/883

(57) ABSTRACT

This invention relates to a substrate (1) with a reception surface (4) for a layer of material to be insolated by insolation light, wherein means forming a mirror (3) are arranged between said reception surface (4) and the layer of material to be insolated, these means forming a mirror (3) operating for the wavelength of the insolation light. This type of substrate may be used for making microelectronic or microtechnological devices, or biochips.

### DESCRIPTION

1. Technical Field

This invention relates to a substrate with a reception surface for a layer of material to be insolated. It is applicable particularly for making biochips.

2. State of Prior Art

The document entitled “Light-generated oligonucleotide arrays for rapid DNA sequence analysis” by A. C Pease et al. published in the Proceedings of the National Academy of Sciences USA, Vol. 91, pages 5022 to 5026, May 1994, divulges a technique for in situ synthesis of biological probes using a photodeprotection method. This technique requires high insolation doses of 4.5 minutes exposure at 14.5 mW/cm² for an insolation light wavelength equal to 365 nm. The energy produced is then 4 J/cm².

The document “The Efficiency of Light-Directed Synthesis of DNA arrays on Glass Substrates” by G. H. McGall et al, published in J. Am. Chem. Soc., Vol 119, No. 22, pages 5081 to 5090, 1997, appears to recommend exposure for 2 minutes at 30 mW/cm² at a wavelength of 365 nm (cut-off filter below 340 nm) with an energy of 6 J/cm². In fact, the deprotection rate is proportional to the light intensity in the range between 5 and 50 mW/cm².

The document “Maskless fabrication of light-directed oligonucleotide microarrays using a digital micromirror array” by S. Singh-Gasson et al. published in Nature Biotechnology, Vol. 17, October 1999, divulges a maskless technique using mirrors. The insolation lasts for 4 minutes for 20 mW/cm² at 365 nm (one filter cuts off below 340 nm and another is used for infrared light). This corresponds to an intensity of 4.8 J/cm².

The techniques divulged in these documents use large insolation doses. These doses are even so high that precautions have to be taken about absorption of the substrate supporting the material to be insolated and the resulting temperature rise. The substrate can expand. This expansion phenomena during insolation can create a problem in the integration system in the case of an increasingly integrated technology.

One solution to this problem is to use substrates made of synthetic silica to minimise the expansion phenomenon. However, these substrates are very expensive compared with standard glass substrates, and are about 20 times more expensive.

This problem of high energy generated during insolation is applicable to the DNA chips. It is also applicable for all biological functionalisations of devices controlled by light at doses that can be damaging for the devices. This method of functionalising devices is very well established in the state of the art. For example, the following documents are relevant to this purpose:

“Using self-assembled monolayers to understand the interactions of man-made surfaces with proteins and cells” by M. Mrksich et al. published in Annu. Rev. Biophys. Biomol. Struct., 1996, Vol. 25, pages 55 to 78. This document states this method as being one of the most frequently used methods of writing biological patterns on a surface.

“Light-dependent, covalent immobilization of biomolecules on inert surfaces” by H. Sigrist et al., published in Bio/Technology, Vol. 10, September 1992, pages 1026 to 1028. The claimed insolation doses are also of the same order of magnitude as those mentioned above for DNA chips; 1 mW/cm² for 20 minutes, giving 1.2 J/cm², still at about 320-380 nm.

Z. P. Yang and A. Chiltoki at the Biosensors 2000 conference in their paper “Light activated affinity micropatterning of proteins”, mentioning immobilisation of proteins by photodeprotection or photoactivation, still using the same wavelengths.

### SUMMARY OF THE INVENTION

The invention provides a solution to the problem mentioned above by the formation of a mirror operating at the wavelength used for the insolation step, located on the surface concerned of a substrate.

Therefore, the first purpose of the invention is a substrate with a reception surface for a layer of material to be insolated by insolation light, characterised in that means forming the mirror are arranged between said reception surface and the layer of material to be insolated, these means forming a mirror operating for the wavelength of the insolation light.

The means forming a mirror for the insolation wavelength may also be designed for the transmission of a light beam to use the devices made on the substrate. When the means forming the mirror can no longer be removed after the insolation operation, this provides a means of obtaining a total or partial (controlled) transmission function at the wavelength at which the finally produced component will be used (for example reading by fluorescence measurement). If the substrate is capable of transmitting a luminescence signal, the means forming the mirror can have a refraction index greater than the refraction index of the substrate and their thickness can be chosen to transmit all or some of the luminescence signal that is thus amplified.

Advantageously, the means forming a mirror comprise one or several optical layers. They can include several optical layers including a Bragg structure type stack. In this case, each optical layer in the stack may have an optical thickness (in other words the product of the refraction index of a layer by its mechanical thickness) equal to a quarter of the wavelength of the insolation light. The thickness of each optical layer in the stack may be calculated such that the means forming a mirror reflect at least 95% of the insolation light and transmit most of an operations light beam, about 8% of this operations light beam being reflected. The stack may be composed of an alternation of HfO₂ and SiO₂ layers. It may be terminated on the side opposite the substrate by a layer of SiO₂.

The means forming a mirror may be composed of one or several materials chosen from among TiO₂, HfO₂, TaO₅, SiO₂, SiC, amorphous Si, YF₃, MgF₂ and LiF.

The substrate may be composed of a silicon or borosilicate support, or a support made of polymer(s), borosilicated or non-borosilicated glass, or silica supporting the means forming a mirror.

A second purpose of the invention consists of a microelectronic device made on such a substrate.

A third purpose of the invention consists of a microtechnological device made on such a substrate.

A fourth purpose of the invention is a biochip made on such a substrate.

A fifth purpose of the invention consists of a process for making a microelectronic or microtechnological device or a biochip from a substrate, the process comprising the formation of a layer of material to be insolated on a reception surface of the substrate, the process also comprising, after insolation of said layer, subsequent steps of realization of the microelectronic or microtechnological device or the biochip, characterised in that the process comprises the formation of means forming a mirror at said reception surface, that function for the wavelength of the insolation light of the layer to be insolated, before formation of the layer to be insolated.

The layer to be insolated may be a photosensitive resin or a layer comprising photosensitive molecules involved in procedures for photodeprotection or photoactivation of the treatment, or the use of a biochip.

After insolation of said layer of material, the process may comprise a step consisting of eliminating all or some of the means forming a mirror. All or some of the means forming a mirror may be eliminated during subsequent steps to make the microelectronic or microtechnological device or the biochip.

The means forming a mirror may be formed by deposition of layers superposed on a support, the free face of the superposed layers forming the reception surface of the substrate.

Microtechnological devices denote devices made by using microtechnologies; micro-accelerator, pressure micro-sensor or other physical parameters, microguide, optics micro-device. These devices can be made on the substrate before or after deposition of the insolation layer. For example, document FR-A-2 700 003 describes the manufacture of a pressure sensor using the silicon on insulator technology and document FR-A-2 700 012 divulges an integrated accelerometer.

### BRIEF DESCRIPTION OF THE DRAWINGS

The invention will be better understood and other advantages and special features will appear after reading the following description given as a non-limitative example accompanied by the attached drawings among which:

FIG. 1 is a side view of a substrate for a material to be insolated according to this invention,

FIG. 2 is a diagram showing reflection in normal incidence as a function of the wavelength of an incident light beam for a first substrate according to the invention,

FIG. 3 is a diagram representing reflection in normal incidence as a function of the wavelength of an incident light beam for a second substrate according to the invention.

### DETAILED DESCRIPTION OF EMBODIMENTS OF THE INVENTION

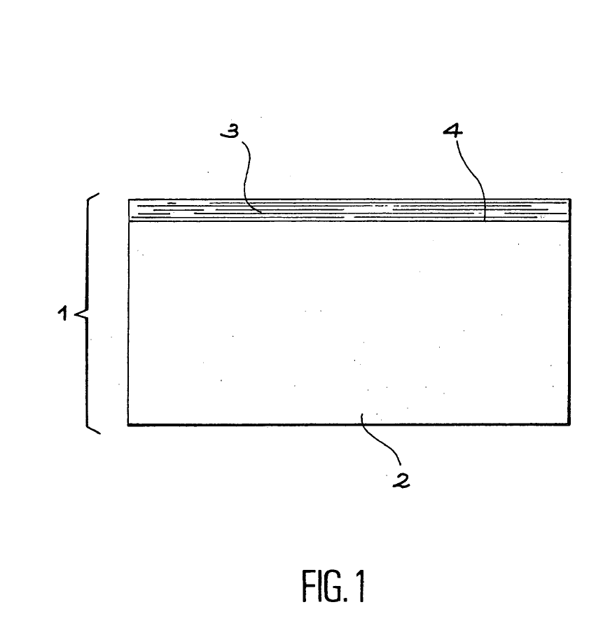

FIG. 1 shows a substrate according to the invention. The substrate 1 is composed of a support 2 supporting a mirror 3 on one of its main faces, called the reception face 4.

For example, the support 2 may be made of silica, borosilicate, plastic or glass. Its refraction index is between 1.4 and 1.6.

In this example, the mirror 3 is an example of the production of a stack of Bragg structure type dielectric layers based on the HfO2/SiO₂ couple, the layers being stacked and alternating. HfO₂ is an oxide with a high refraction index (denoted H) in the visible domain and silica SiO₂ has a low refraction index (denoted B). By making a stack of layers of these two materials, for which the optical thicknesses are equal to a quarter of the wavelength of 365 nm and also called the mirror centring wavelength, it is easy to achieve the value of 95% as being the reflection capacity of the mirror at this wavelength.

The expression “optical thickness” means the product of the refraction index n and the mechanical thickness of the thin layer for the wavelength considered. Several production techniques are possible for these stacks: evaporation by electron gun, reactive radio frequency sputtering, ion beam sputtering, liquid phase deposition by sol-gel.

The refraction indexes obtained for the insolation wavelength of 365 nm and for the ion beam sputtering (IBS) deposition technique, are 2.25 for HfO₂ and 1.51 for SiO₂. Under these conditions, the mechanical thicknesses for the thin layers are 41 nm for a layer of HfO₂ and 61 nm for a layer of SiO₂. The specular reflection obtained for a stack composed of six times the basic sequence (41 nm of HfO₂ and 61 nm of SiO₂), is 95%.

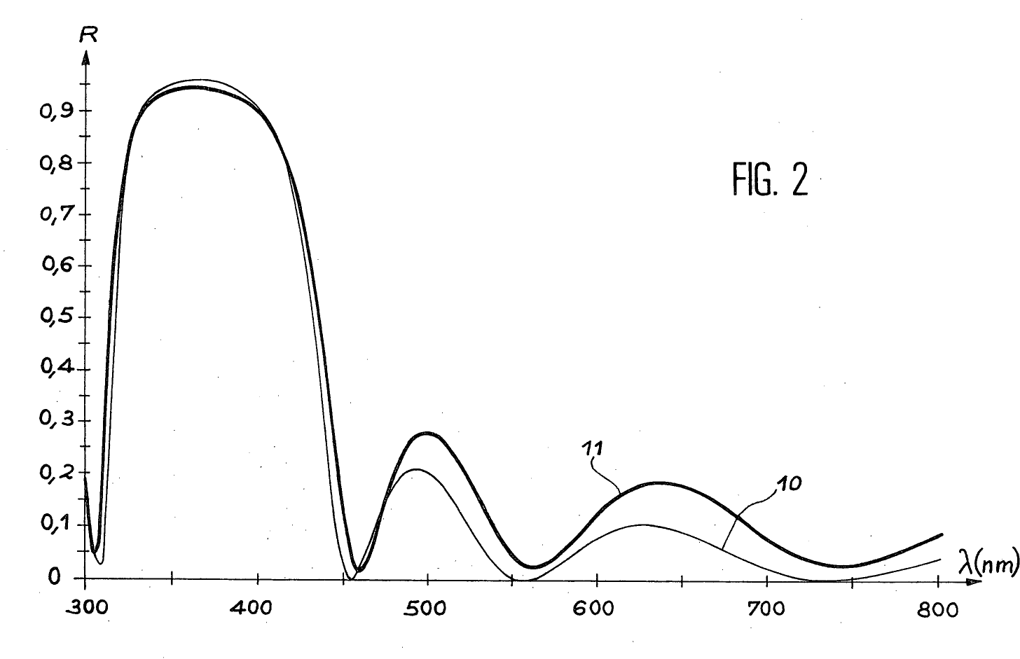

The diagram in FIG. 2 shows the shape of the reflection R in normal incidence as a function of the wavelength λ. The curve 10 relates to a reflection in liquid medium while curve 11 relates to reflection in air. Note that the optical properties for use in a liquid medium are practically unchanged if the support is changed (borosilicate or silica).

For reasons of biological compatibility (grafting of oligonucleotide probes), it may be useful to terminate the stack with a thin layer of SiO₂. However, the stack can always be terminated with a layer of HfO₂ without causing any significant variation in the optical properties of the stack.

For some applications of a biochip, it may be possible to guarantee a residual reflection of the order of 8% in the absorption range of a fluorophore. This residual reflection is defined in the operating mode of the biochip., namely in a liquid medium. The fluorophore used may be CY5, for which the absorption band is located approximately around 650 nm.

In the case of the Bragg mirror described above, the diagram in FIG. 2 shows that the reflection at 650 nm is located on an interference fringe, and therefore is not in an extremum. This can cause problems of technological robustness and it is preferable to work on an interference extremum.

A mathematic optimisation method can be used to place the extremum at 650 nm. With this approach, the following stack was obtained:

Substrate/37 H 63 B 46 H 56 B 43 H 61 B 35 H 61 B 44 H 69 B 40 H 80 B/air or water.

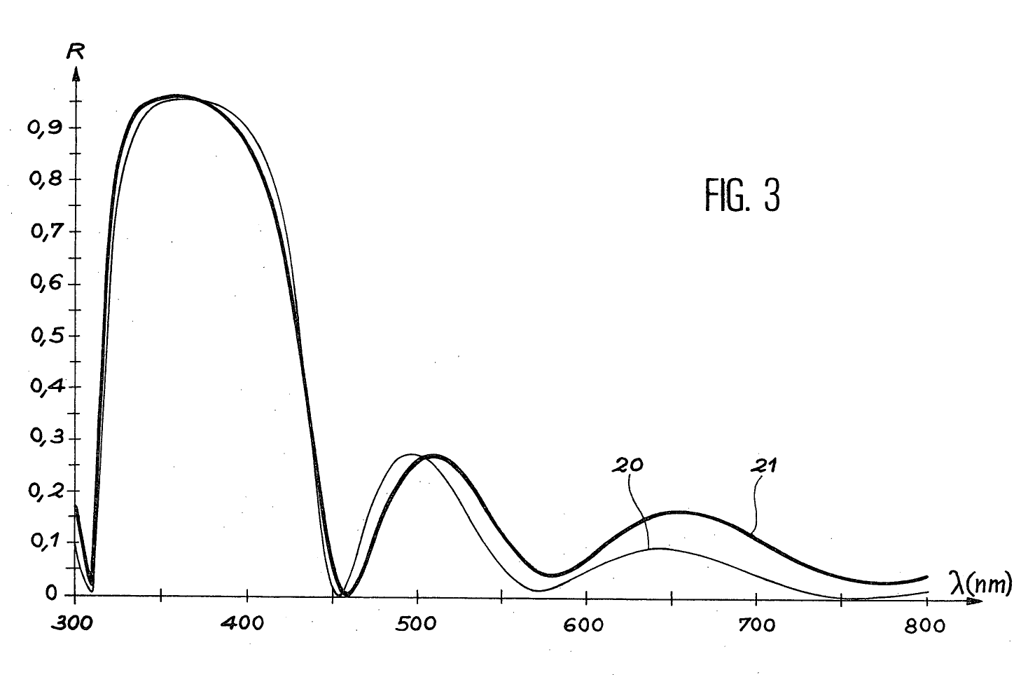

The numbers denote the thickness of the layers denoted H or B (defined above) in nm. With this stack, the optical properties described by the diagram in FIG. 3 are obtained. The curve 20 is related to a reflection in a liquid medium, while curve 21 is related to a reflection in air.

Due to optimisation of the residual reflection at the absorption wavelength of the fluorophore, it is possible to simultaneously envisage reinforcement of fluorescence in transmission. Thus, reinforcement of the fluorescence can be combined with optimisation of the reflection at the wavelength of the insolation light together with a guarantee of a reflection of about 8% for the absorption wavelength of the fluorophore.

The invention is means of relaxing absorption and expansion specifications in materials used as substrates. These specifications can be very severe in the case of glass: reflection at the air-glass interface 4%, and 96% of the insolation energy not absorbed by the resin (material to be insolated) enters the substrate. The problem of reflection on the back face of the substrate is eliminated. This parasite reflection can reduce the resolution of the photolithography. Production of a mirror on the surface of the substrate can thus reduce insolation doses during photolithography and thus protect equipment necessary at this step (life of lamps, resistance of lenses to the flux). By relaxing the severity of the specifications for substrate materials, procurement costs are reduced, consequently making it possible to use new materials (for example plastic).

1. Substrate (1) with a reception surface (4) for a layer of material to be insolated by insolation light, characterised in that means forming a mirror (3) are arranged between said reception surface (4) and the layer of material to be insolated, these means forming a mirror (3) operating for the wavelength of the insolation light.

2. Substrate according to claim 1, characterised in that the means forming a mirror (3) for the insolation wavelength are also designed for the transmission of a light beam to use the devices made on the substrate.

3. Substrate according to claim 2, characterised in that the substrate (1) is capable of transmitting a luminescence signal, and the means forming a mirror (3) have a refraction index greater than the refraction index of the substrate, and their thickness is chosen to transmit all or some of the luminescence signal that is thus amplified.

4. Substrate according to claim 1, characterised in that the means forming a mirror (3) comprise one or several optical layers.

5. Substrate according to claim 4, characterised in that the means forming a mirror (3) comprise several optical layers including a Bragg structure type stack.

6. Substrate according to claim 5, characterised in that each optical layer in the stack may have an optical thickness (in other words the product of the refraction index of a layer by its mechanical thickness) equal to a quarter of the wavelength of the insolation light.

7. Substrate according to claim 5, characterised in that the thickness of each optical layer in the stack is calculated such that the means forming a mirror reflect at least 95% of the insolation light and transmit most of an operations light beam, about 8% of this operations light beam being reflected.

8. Substrate according to any one of claims 1 to 7, characterised in that the means forming a mirror are composed of one or several materials chosen from among TiO₂, HfO₂, TaO₅, SiO₂, SiC, amorphous Si, YF₃, MgF₂ and LiF.

9. Substrate according to claim 5, characterised in that said stack is composed of an alternation of HfO₂ and SiO₂ layers.

10. Substrate according to claim 9, characterised in that the stack is terminated on the side opposite the substrate by a layer of SiO₂.

11. Substrate according to claim 1, characterised in that it is composed of a silicon or borosilicate support, or a support made of polymer(s), borosilicated or non-borosilicated glass, or silica supporting the means forming a mirror.

12. Microelectronic device, characterised in that it is made on a substrate according to any one of the above claims.

13. Microtechnological device, characterised in that it is made on a substrate according to any one of claims 1 to 11.

14. Biochip, characterised in that it is made on a substrate according to any one of claims 1 to 11.

15. Process for making a microelectronic or microtechnological device or a biochip from a substrate, the process comprising the formation of a layer of material to be insolated on a reception surface of the substrate, the process also comprising, after insolation of said layer, subsequent steps of the realization of the microelectronic or microtechnological device or the biochip characterised in that the process comprises the formation of means forming a mirror at said reception surface, that function for the wavelength of the insolation light of the layer to be insolated, before formation of the layer of material to be insolated.

16. Process according to claim 15, characterised in that the layer to be insolated is a photosensitive resin or a layer comprising photosensitive molecules involved in procedures for photodeprotection or photoactivation of the treatment, or the use of a biochip.

17. Process according to claim 15, characterised in that it comprises a step after insolation of said layer of material, consisting of eliminating all or some of the means forming a mirror.

18. Process according to claim 17, characterised in that all or some of the means forming a mirror are eliminated during subsequent steps to make the microelectronic or microtechnological device or the biochip.

19. Process according to claim 15, characterised in that the means forming a mirror are formed by deposition of layers superposed on a support, the free face of the superposed layers forming the reception surface of the substrate.
